(19) United States
(12) Patent Application Publication
(10) Pub. No.: US 2024/0337299 A1
(43) Pub. Date: Oct. 10, 2024

(54) SELF-LEVELING DAMPER

(71) Applicants: Hyundai Motor Company, Seoul (KR); Kia Corporation, Seoul (KR); HL Mando Corporation, Pyeongtaek-si (KR)

(72) Inventors: Hyung Shik SHIM, Hwaseong-Si (KR); Ga Ram BARK, Hwaseong-Si (KR); Hyung Nam KIM, Yongin-Si (KR)

(73) Assignees: Hyundai Motor Company, Seoul (KR); Kia Corporation, Seoul (KR); HL Mando Corporation, Seoul (KR)

(21) Appl. No.: 18/373,155

(22) Filed: Sep. 26, 2023

(30) Foreign Application Priority Data
Apr. 7, 2023 (KR) 10-2023-0045799

(51) Int. Cl. F16F 9/18

(52) U.S. Cl. CPC F16F 9/185

(57) ABSTRACT

A self-leveling damper includes a plurality of ribs formed on an internal circumferential surface of a rectilinear portion of a diaphragm to maintain flow paths between an external tube and the diaphragm, a step portion which prevents the blocking of a relief valve hole flow path by an upper holder coupling portion and is formed on a lower surface of an upper holder, wherein an upper edge portion of each of lower holder flow paths is formed as a round surface which is a curved surface so that damage to a lower holder coupling portion may be prevented.

### CROSS REFERENCE TO RELATED APPLICATIONS

The present application claims priority to Korean Patent Application No. 10-2023-0045799, filed Apr. 7, 2023, the entire contents of which is incorporated herein for all purposes by this reference.

### BACKGROUND OF THE PRESENT DISCLOSURE

### Field of the Present Disclosure

The present disclosure relates to a self-leveling damper applied to a rear wheel of a vehicle.

### Description of Related Art

A damper of a vehicle is a shock absorber which is provided between an axle and a vehicle body to absorb vibration and impact that the axle receives from a road surface during vehicle driving to improve ride quality.

In general, a wagon or a sports utility vehicle (SUV) is frequently loaded with a larger amount of luggage in a trunk due to the characteristics of the vehicle compared to a sedan.

In the instant case, the rear of a vehicle has height decreased due to an additional load applied to a rear wheel, and as a result, a load input from a road surface is increased, deteriorating ride comfort.

To improve this, a self-leveling damper is applied to a rear wheel to compensate for the deflection of a vehicle due to an increased load.

The self-leveling damper is a device that increases the pressure of an internal chamber with forces of the bump and rebound stroke of a shock absorber during vehicle driving to lift a vehicle to a predetermined level, compensating for weight caused by loading and reducing the amount of deflection.

The self-leveling damper is provided with a relief valve, wherein when the pressure of a high pressure chamber rises excessively, the relief valve is opened so that the oil of the high pressure chamber is sent to a low pressure chamber to manage the maximum pressure of the high pressure chamber.

However, even though the conventional self-leveling damper is provided with the relief valve, the conventional self-leveling damper has the structural problem of reducing a side flow path due to the expansion of a diaphragm during the compression and tension of the damper in the structures of the diaphragm and an upper holder and of the diaphragm and a lower holder, so the movement of oil from the high pressure chamber to the low pressure chamber is not efficient, which excessively raises the pressure of the high pressure chamber, causing damage to parts due to the reduction of durability of the parts and generating severe noise.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a self-leveling damper which prevents the blocking of the flow of oil between a high pressure chamber and a low pressure chamber during compression and tension of a damper by improving the shapes of a diaphragm, an upper holder, and a lower holder so that the pressure of the high pressure chamber may be prevented from excessively rising, improving durability of parts and reducing noise, and preventing tearing of the diaphragm to prevent leakage of oil.

To achieve the objectives of the present disclosure, there is provided a self-leveling damper including: an upper holder and a lower holder located respectively at positions spaced from each other in a longitudinal direction of a cylinder and provided between an external tube and the cylinder, and a diaphragm coupled to the upper holder and the lower holder at first and second end portions of the diaphragm, respectively, wherein a plurality of ribs are formed on an internal circumferential surface of the diaphragm by protruding inward from the internal circumferential surface of the diaphragm.

The diaphragm as a cylindrical tube made of rubber may include: a rectilinear portion located at a middle portion of the diaphragm, the rectilinear portion including a same diameter over an entire length of the rectilinear portion and including the ribs formed on the internal circumferential surface of the diaphragm; an upper holder coupling portion formed to include a diameter increasing from a first end portion of the rectilinear portion, with an end portion of the upper holder coupling portion being coupled to the upper holder; and a lower holder coupling portion formed to include a diameter increasing gradually from a second end portion of the rectilinear portion, with an end portion of the lower holder coupling portion being coupled to the lower holder.

With each of the ribs being formed to include same length as the length of the rectilinear portion, a plurality of ribs may be formed to be located symmetrically along a circumferential direction of the rectilinear portion.

When the diaphragm is partially transformed by oil pressure, the ribs may contact with an external surface of the external tube so that flow paths formed between the external tube and the diaphragm are maintained to be unblocked due to the ribs.

A length of the upper holder coupling portion may be longer than a straight length between internal and external diameters of a lower surface of the upper holder, so even when the diaphragm is transformed due to oil pressure, the upper holder coupling portion may be prevented from contacting with the lower surface of the upper holder.

The length of the upper holder coupling portion may be at least twice as long as the straight length between the internal and external diameters of the lower surface of the upper holder.

A length of the lower holder coupling portion may be longer than a straight length between internal and external diameters of an upper surface of the lower holder, so even when the diaphragm is transformed due to oil pressure, the lower holder coupling portion may be prevented from contacting with the upper surface of the lower holder.

The length of the lower holder coupling portion may be at least twice as long as the straight length between the internal and external diameters of the upper surface of the lower holder.

A step portion may be formed on a lower surface of the upper holder, so even though the diaphragm is transformed due to oil pressure, a relief valve hole flow path formed in the upper holder may be maintained so as not to be blocked by the diaphragm due to the step portion.

The step portion may be formed as a groove concavely recessed toward an upper side of the upper holder by starting from an outermost point of the relief valve hole flow path on the lower surface of the upper holder.

A plurality of lower holder flow paths may be formed on an internal surface of the lower holder, wherein an upper edge portion of each of the lower holder flow paths may be formed as a round surface, so that even when the diaphragm is transformed due to oil pressure applied thereto and contacts with the round surface, damage to the diaphragm may be prevented due to the round surface.

According to the self-leveling damper according to an exemplary embodiment of the present disclosure, the plurality of ribs are formed on the internal circumferential surface of the rectilinear portion of the diaphragm by protruding inward therefrom, and thus even though the diaphragm is transformed due to oil pressure, the ribs contact with the external surface of the external tube so that the flow paths formed between the external tube and the diaphragm may be constantly maintained, so that the oil of the high pressure chamber can easily move through the flow paths to a low pressure chamber, preventing excessive pressure rise of the high pressure chamber, damage to portions, and noise due to the pressure rise.

Furthermore, according to an exemplary embodiment of the present disclosure, the step portion is formed on the starting point of the relief valve hole flow path on the lower surface of the upper holder. Accordingly, even when the upper holder coupling portion of the diaphragm is transformed due to oil pressure applied thereto and contacts with the lower surface of the upper holder, the relief valve hole flow path formed in the upper holder is prevented from being blocked by the upper holder coupling portion due to the step portion, preventing excessive pressure rise of the high pressure chamber, damage to portions, and noise due to the pressure rise.

Furthermore, in the exemplary embodiment the exemplary embodiment of the present disclosure, the upper edge portion of each of the lower holder flow paths formed in the lower holder is formed as a round surface, and thus even when the lower holder coupling portion of the diaphragm is transformed due to oil pressure applied thereto and contacts with the round surface, damage to the lower holder coupling portion may be prevented due to the round surface which is a smooth curved surface, and accordingly, oil leakage may be prevented.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a self-leveling damper according to an exemplary embodiment of the present disclosure;

FIG. 2 is a view exemplarily illustrating a diaphragm, an upper holder, and a lower holder according to an exemplary embodiment of the present disclosure;

FIG. 3 is an enlarged view of the coupled portion of the lower holder in FIG. 1;

FIG. 4 is a cross-sectional view of a rectilinear portion of the diaphragm in FIG. 2;

FIG. 5 is a sectional view of the upper holder in which a step portion is formed according to an exemplary embodiment of the present disclosure;

FIG. 6 is an enlarged view of the coupled portion of the upper holder in FIG. 1;

FIG. 7 is a view of the lower holder in which the upper edge portion of each of lower holder flow paths is formed as a round surface according to an exemplary embodiment of the present disclosure; and

FIG. 8 is a view exemplarily illustrating a state in which a lower holder coupling portion transformed due to oil pressure is in contact with the round surface of the lower holder flow path according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereafter, an exemplary embodiment of the present disclosure will be described in detail with reference to the accompanying drawings and the same or similar components are provided the same reference numerals regardless of the numbers of figures and are not repeatedly described.

Terms “module” and “unit” that are used for components in the following description are used only for the convenience of description without having discriminate meanings or functions.

In the following description, if it is decided that the detailed description of known technologies related to the present disclosure makes the subject matter of the exemplary embodiment described herein unclear, the detailed description is omitted.

Furthermore, the accompanying drawings are provided only for easy understanding of the exemplary embodiment included in the specification, and the technical spirit included in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be directly connected to or directly coupled to another element or be connected to or coupled to another element, having the other element intervening therebetween.

On the other hand, it should be understood that when one element is referred to as being “directly connected to” or “directly coupled to” another element, it may be connected to or coupled to another element without the other element intervening therebetween.

Singular forms are intended to include plural forms unless the context clearly indicates otherwise.

It will be further understood that the terms “comprise” or “have” used in the present specification, specify the presence of stated features, steps, operations, components, parts, or a combination thereof, but do not preclude the presence or addition of one or more other features, numerals, steps, operations, components, parts, or a combination thereof.

Furthermore, a unit or control unit included in terms such as a motor control unit (MCU) and a hybrid control unit (HCU) is just a term widely used for naming a controller that controls a specific function of a vehicle, but does not mean a generic function unit.

A controller may include a communication device that communicates with another controller or a sensor to control corresponding functions, a memory that stores an operating system or logic commands and input/output information, and one or more processors that perform determination, calculation, decision, etc. For controlling the corresponding functions.

Hereinafter, a self-leveling damper according to the exemplary embodiment of the present disclosure will be described with reference to the accompanying drawings.

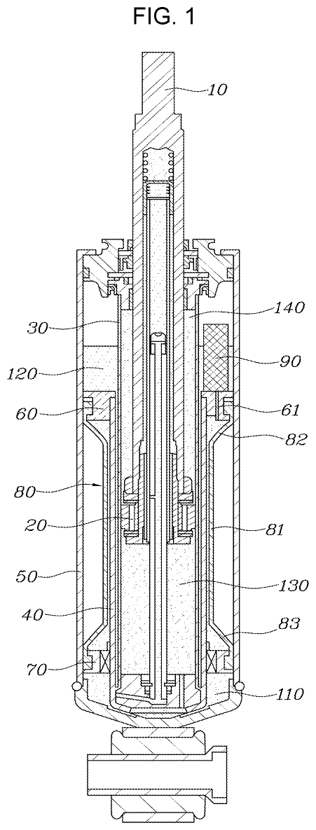

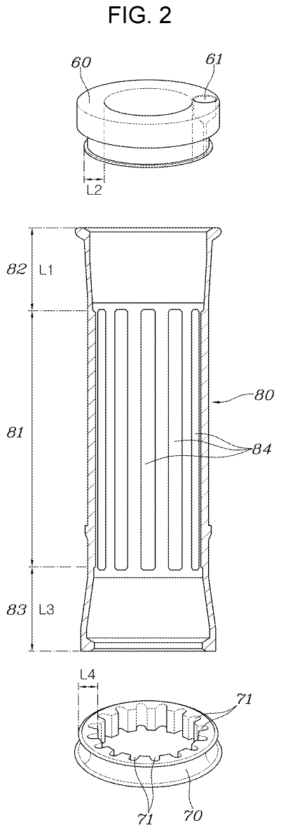

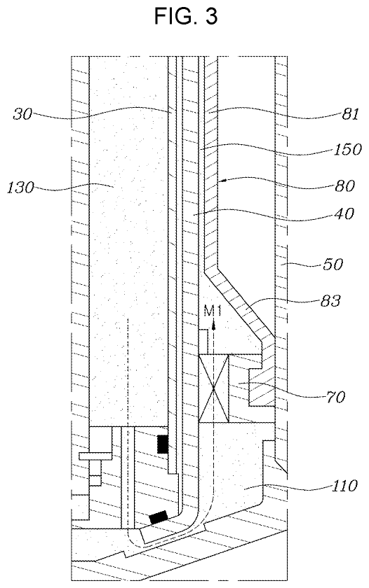

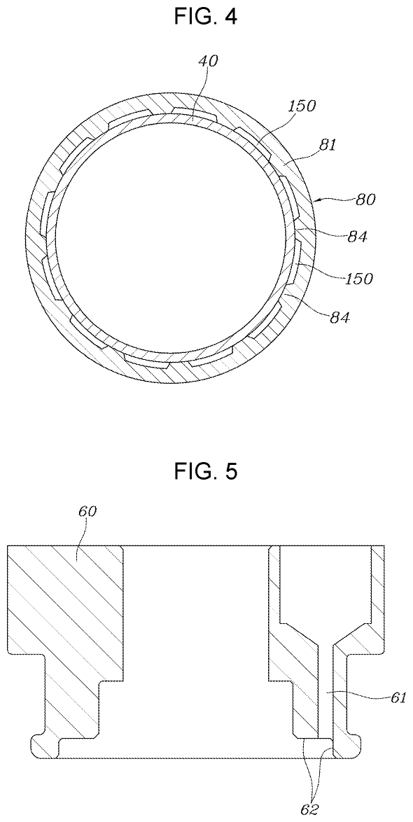

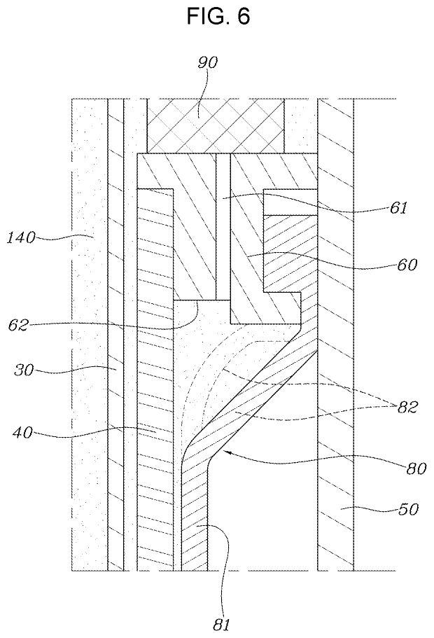

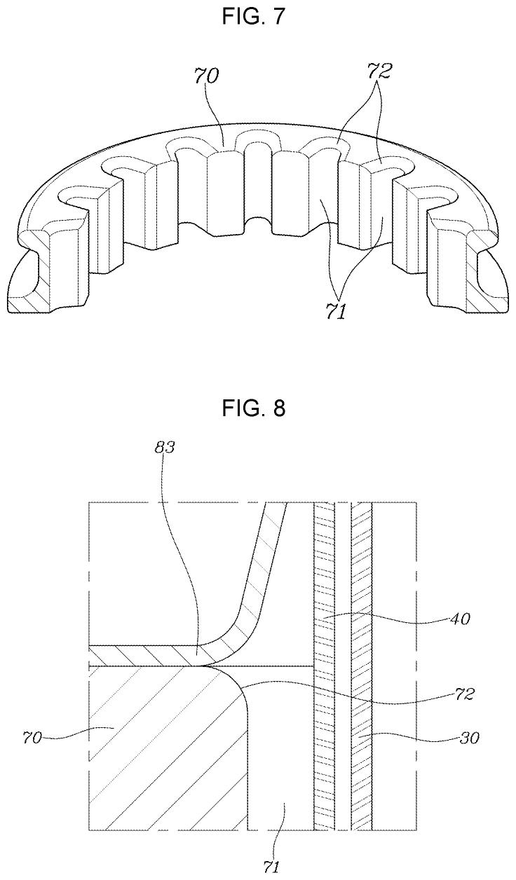

As illustrated in FIG. 1, FIG. 2, FIG. 3, FIG. 4, FIG. 5, FIG. 6, FIG. 7, and FIG. 8, the self-leveling damper according to an exemplary embodiment of the present disclosure includes a piston rod 10, a piston valve 20, an internal tube 30 which guides the movement of the piston valve 20 and is filled with oil, an external tube 40 surrounding the internal tube 30, and a cylinder 50 which surrounds the external tube 40 and is coupled to an axle of a rear wheel at a lower end portion thereof.

The upper end portion of the piston rod 10 is coupled to a vehicle body, and the piston valve 20 is coupled to the lower end portion of the piston rod 10.

Furthermore, the self-leveling damper further includes an upper holder 60 welded to the external tube 40 and provided between the upper end portion of the external tube 40 and the cylinder 50, a lower holder 70 fitted over the external tube 40 and provided between the lower end portion of the external tube 40 and the cylinder 50, a diaphragm 80 fitted over the external tube 40 and located between the external tube 40 and the cylinder 50, the upper and lower end portions of the diaphragm being coupled to the upper holder 60 and the lower holder 70, respectively, and a relief valve 90 coupled to the upper holder 60.

The diaphragm 80 is formed of a cylindrical tube made of rubber, and the relief valve 90 is provided on a relief valve hole flow path 61 formed in the upper holder 60 and is opened when the pressure of a high pressure chamber 110 rises excessively. Through this, the relief valve 90 allows oil of the high pressure chamber 110 to be transmitted to a low pressure chamber 120 and is configured to manage the maximum pressure of the high pressure chamber 110.

Accordingly, during a compression stroke (a bump stroke) in which the piston valve 20 descends, oil located in a lower chamber 130 of the piston valve 20 moves to an upper chamber 140 and the high pressure chamber 110, and during a tension stroke (a rebound stroke) in which the piston valve 20 rises, oil located in the upper chamber 140 of the piston valve 20 and the high pressure chamber 110 moves to the lower chamber 130 and the low pressure chamber 120. Through this, the self-leveling damper exerts a damping force during bumps and rebounds.

Furthermore, when the compression stroke of the piston valve 20 continues and the pressure rise of the high pressure chamber 110 occurs, the position of the piston valve 20 is reversely raised to adjust vehicle height. In the instant case, when the pressure of the high pressure chamber 110 rises excessively, the relief valve 90 is opened and the pressure of the high pressure chamber 110 is discharged to the low pressure chamber 120, so that the pressure of the high pressure chamber 110 is properly maintained at a predetermined level.

The diaphragm 80 of the self-leveling damper according to an exemplary embodiment of the present disclosure is formed as a cylindrical tube made of rubber, and includes a rectilinear portion 81 formed to have the same diameter over an entire length thereof and located at a middle portion of the diaphragm 80; an upper holder coupling portion 82 formed to have a diameter increasing from a first end portion of the rectilinear portion 81, with an end portion of upper holder coupling portion 82 being coupled to the upper holder 60; and a lower holder coupling portion 83 formed to have a diameter increasing gradually from a second end portion of the rectilinear portion 81, with an end portion of lower holder coupling portion 83 being coupled to the lower holder 70.

Furthermore, a plurality of ribs 84 are formed on the internal circumferential surface of the rectilinear portion 81 of the diaphragm 80 by protruding inward therefrom.

When the pressure of the high pressure chamber 110 rises due to the compression stroke of the piston valve 20, the oil pressure of the high pressure chamber 110 passes upward through the lower holder 70 and is transmitted to the diaphragm 80 as shown by an arrow M1 of FIG. 3, and the rectilinear portion 81 of the diaphragm 80 is contracted by the oil pressure. In the instant case, the ribs 84 formed on the internal circumferential surface of the rectilinear portion 81 are in contact with the external surface of the external tube 40 as shown in FIG. 4.

When the ribs 84 contact with the external surface of the external tube 40 due to the transformation of the diaphragm 80 caused by the oil pressure, the blocking of flow paths 150 between the external tube 40 and the diaphragm 80 is prevented by the ribs 84. Because of this, the oil of the high pressure chamber 110 may easily move through each of the flow paths 150 to the low pressure chamber 120, preventing damage to portions and generation of noise.

In the conventional technology, no rib is formed on an internal surface of the diaphragm 80, and thus when the diaphragm 80 is transformed due to oil pressure during the compression stroke of the piston valve 20, the internal surface of the diaphragm 80 contacts with the external surface of the external tube 40, so that the flow paths between the external tube 40 and the diaphragm 80 are blocked.

When the flow paths between the external tube 40 and the diaphragm 80 are blocked, the oil of the high pressure chamber 110 may not move to the low pressure chamber 120, so that the pressure of the high pressure chamber 110 may rise excessively, resulting in damage to portions and severe noise.

However, in the exemplary embodiment the exemplary embodiment of the present disclosure, the plurality of ribs 84 are formed on the internal circumferential surface of the rectilinear portion 81 of the diaphragm 80, and thus the flow paths 150 between the external tube 40 and the diaphragm 80 are constantly maintained by the ribs 84, preventing excessive pressure rise of the high pressure chamber 110, damage to portions, and noise due to the pressure rise.

Each of the plurality of ribs 84 formed in the diaphragm 80 according to an exemplary embodiment of the present disclosure is formed to have the same length as the length of the rectilinear portion 81, and is to be located symmetrically along the circumferential direction of the rectilinear portion 81. Through this, the plurality of ribs 84 may more stably contact with the external surface of the external tube 40, so that the flow paths 150 are more easily secured by the ribs 84.

Furthermore, in the diaphragm 80, the length L1 of the upper holder coupling portion 82 is longer than a straight length L2 between internal and external diameters of the lower surface of the upper holder 60. Through this, even when the diaphragm 80 is transformed due to oil pressure, the upper holder coupling portion 82 is prevented from contacting with the lower surface of the upper holder 60, so that the openness of the flow paths 150 toward the low pressure chamber 120 is constantly maintained.

To prevent the upper holder coupling portion 82 from contacting with the lower surface of the upper holder 60 during the transformation of the diaphragm 80 due to oil pressure, the length L1 is preferably at least twice as long as the length L2, but is not limited thereto.

Furthermore, in the diaphragm 80, the length L3 of the lower holder coupling portion 83 is longer than the upper surface in a straight length L4 between the internal and external diameters of the lower holder 70. Through this, even when the diaphragm 80 is transformed due to oil pressure, the lower holder coupling portion 83 is prevented from contacting with the upper surface of the lower holder 70, so that the openness of the flow paths 150 toward the high pressure chamber 110 is constantly maintained and, the lower holder coupling portion 83 is prevented from being damaged by contacting with the upper end portion of the lower holder 70.

To prevent the lower holder coupling portion 83 from contacting with the upper surface of the lower holder 70 during the transformation of the diaphragm 80 due to oil pressure, the length L3 is preferably at least twice as long as the length L4, but is not limited thereto.

Furthermore, in the exemplary embodiment the exemplary embodiment of the present disclosure, a step portion 62 is formed on the lower surface of the upper holder 60, so even though the diaphragm 80 is transformed due to oil pressure, the relief valve hole flow path 61 formed in the upper holder 60 is maintained so as not to be blocked by the diaphragm 80 due to the step portion 62.

The step portion 62 of the upper holder 60 is formed as a groove concavely recessed toward the upper side of the upper holder 60 by starting from the outermost point of the relief valve hole flow path 61 on the lower surface of the upper holder 60 and is formed as a groove concavely recessed upward into the upper holder 60.

When the oil pressure of the high pressure chamber 110 is transmitted to the upper holder coupling portion 82 of the diaphragm 80 due to the compression stroke of the piston valve 20, the upper holder coupling portion 82 is bent toward the upper holder 60 as shown in the dotted line of FIG. 6.

In the instant case, when the step portion 62 is not formed on the lower surface of the upper holder 60, the transformed upper holder coupling portion 82 contacts with the lower surface of the upper holder 60 and blocks the relief valve hole flow path 61, and when the relief valve hole flow path 61 is blocked, the relief valve 90 does not operate and oil does not move to the low pressure chamber 120, resulting in excessive pressure rise of the high pressure chamber, damage to portions, and severe noise.

To prevent this, in the exemplary embodiment the exemplary embodiment of the present disclosure, the step portion 62 is formed on the starting point of the relief valve hole flow path 61 on the lower surface of the upper holder 60, and thus even when the upper holder coupling portion 82 of the diaphragm 80 is transformed due to oil pressure and is in contact with the lower surface of the upper holder 60, the relief valve hole flow path 61 formed in the upper holder 60 may be prevented from being blocked by the upper holder coupling portion 82 due to the step portion 62, preventing excessive pressure rise of the high pressure chamber, damage to portions, and noise due to the pressure rise.

Furthermore, in the exemplary embodiment the exemplary embodiment of the present disclosure, a plurality of lower holder flow paths 71 connected to the high pressure chamber 110 are formed on the internal surface of the lower holder 70. The upper edge portion of each of the lower holder flow paths 71 is formed as a round surface 72, and thus even when the diaphragm 80 is transformed due to oil pressure and is in contact with the round surface 72, damage to the diaphragm 80 is prevented due to the round surface 72.

As oil moves from the upper chamber 140 and the high pressure chamber 110 to the lower chamber 130 due to the tension stroke of the piston valve 20, the pressure of the oil is transferred to the lower holder coupling portion 83 of the diaphragm 80. In the instant case, as shown in FIG. 8, the lower holder coupling portion 83 is bent toward the lower holder 70 and is in contact with the upper surface of the lower holder 70.

In the instant case, when the upper edge portion of each of the lower holder flow paths 71 is formed to be sharp by including a right angle cross section, the lower holder coupling portion 83 is dent and damaged due to the right angle cross section edge portion of the lower holder flow paths 71, and through the damaged portion, oil leaks.

To prevent this, in the exemplary embodiment the exemplary embodiment of the present disclosure, the upper edge portion of the lower holder flow path 71 is formed as the round surface 72 of an arc shape, and thus even when the lower holder coupling portion 83 of the diaphragm 80 is transformed due to oil pressure and contacts with the round surface 72, damage to the lower holder coupling portion 83 is prevented due to the round surface 72 which is a smooth curved surface so that oil leakage may be prevented.

As described above, in the self-leveling damper according to an exemplary embodiment of the present disclosure, the plurality of ribs 84 are formed on the internal circumferential surface of the rectilinear portion 81 of the diaphragm 80 by protruding inward therefrom, and thus even when the diaphragm 80 is transformed due to oil pressure, the ribs 84 may be in contact with the external surface of the external tube 40 to constantly maintain the flow path 150 between the external tube 40 and the diaphragm 80. Because of this, the oil of the high pressure chamber 110 may easily move through the flow path 150 to the low pressure chamber 120, preventing the excessive pressure rise of the high pressure chamber 110, damage to portions, and noise due to the pressure rise.

Furthermore, in the exemplary embodiment the exemplary embodiment of the present disclosure, the step portion 62 is formed on the starting point of the relief valve hole flow path 61 on the lower surface of the upper holder 60. Accordingly, even when the upper holder coupling portion 82 of the diaphragm 80 is transformed due to oil pressure and contacts with the lower surface of the upper holder 60, the relief valve hole flow path 61 formed in the upper holder 60 is prevented from being blocked by the upper holder coupling portion 82 due to the step portion 62, preventing excessive pressure rise of the high pressure chamber, damage to portions, and noise due to the pressure rise.

Furthermore, in the exemplary embodiment the exemplary embodiment of the present disclosure, the upper edge portion of each of the lower holder flow paths 71 formed in the lower holder 70 is formed as the round surface 72. Even when the lower holder coupling portion 83 of the diaphragm 80 is transformed due to oil pressure and is in contact with the round surface 72, damage to the lower holder coupling portion 83 is prevented due to the round surface 72 including a smooth curved surface, preventing oil leakage.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A self-leveling damper apparatus comprising:
an upper holder and a lower holder located respectively at positions spaced from each other in a longitudinal direction of a cylinder and provided between an external tube and the cylinder, and
a diaphragm coupled to the upper holder and the lower holder at first and second end portions of the diaphragm, respectively between the external tube and the cylinder,
wherein a plurality of ribs are formed on an internal circumferential surface of the diaphragm by protruding inward from the internal circumferential surface of the diaphragm.

2. The self-leveling damper apparatus of claim 1, wherein the diaphragm as a cylindrical tube made of elastic member includes:
a rectilinear portion located at a middle portion of the diaphragm, the rectilinear portion including a same diameter over an entire length of the rectilinear portion and including the ribs formed on the internal circumferential surface of the diaphragm.

3. The self-leveling damper apparatus of claim 2, wherein with each of the ribs being formed to include a same length as the entire length of the rectilinear portion, the plurality of ribs are formed to be located symmetrically along a circumferential direction of the rectilinear portion.

4. The self-leveling damper apparatus of claim 1, wherein the diaphragm as a cylindrical tube made of elastic member includes:
a rectilinear portion located at a middle portion of the diaphragm, the rectilinear portion including a same diameter over an entire length of the rectilinear portion and including the ribs formed on the internal circumferential surface of the diaphragm;
an upper holder coupling portion formed to include a diameter increasing from the first end portion of the rectilinear portion in a first direction, wherein an end portion of the upper holder coupling portion is coupled to the upper holder; and
a lower holder coupling portion formed to include a diameter increasing from the second end portion of the rectilinear portion in a second direction opposite the first direction, with an end portion of the lower holder coupling portion being coupled to the lower holder.

5. The self-leveling damper apparatus of claim 4, wherein the elastic member is a rubber.

6. The self-leveling damper apparatus of claim 4, wherein with each of the ribs being formed to include a same length as the entire length of the rectilinear portion, the plurality of ribs are formed to be located symmetrically along a circumferential direction of the rectilinear portion.

7. The self-leveling damper apparatus of claim 1, wherein when the diaphragm is partially transformed by oil pressure, the ribs contact with an external surface of the external tube so that flow paths formed between the external tube and the diaphragm are maintained to be unblocked due to the ribs.

8. The self-leveling damper apparatus of claim 4, wherein a length of the upper holder coupling portion is longer than a straight length between internal and external diameters of a lower surface of the upper holder, so even when the diaphragm is transformed due to oil pressure, the upper holder coupling portion is prevented from contacting with the lower surface of the upper holder.

9. The self-leveling damper apparatus of claim 8, wherein the length of the upper holder coupling portion is at least twice as long as the straight length between the internal and external diameters of the lower surface of the upper holder.

10. The self-leveling damper apparatus of claim 4, wherein a length of the lower holder coupling portion is longer than a straight length between internal and external diameters of an upper surface of the lower holder, so even when the diaphragm is transformed due to oil pressure, the lower holder coupling portion is prevented from contacting with the upper surface of the lower holder.

11. The self-leveling damper apparatus of claim 10, wherein the length of the lower holder coupling portion is at least twice as long as the straight length between the internal and external diameters of the upper surface of the lower holder.

12. The self-leveling damper apparatus of claim 1, wherein a step portion is formed on a lower surface of the upper holder, so even though the diaphragm is transformed due to oil pressure, a relief valve hole flow path formed in the upper holder is maintained so as not to be blocked by the diaphragm due to the step portion.

13. The self-leveling damper apparatus of claim 12, wherein the step portion is formed as a groove concavely recessed toward an upper side of the upper holder by starting from an outermost point of the relief valve hole flow path on the lower surface of the upper holder.

14. The self-leveling damper apparatus of claim 1,
wherein a plurality of lower holder flow paths are formed on an internal surface of the lower holder, and
wherein an upper edge portion of each of the lower holder flow paths is formed as a round surface, so that even when the diaphragm is transformed due to oil pressure applied thereto and contacts with the round surface, damage to the diaphragm is prevented due to the round surface.
